(19) United States
(12) Patent Application Publication
(10) Pub. No.: US 2014/0272070 A1
(43) Pub. Date: Sep. 18, 2014

(54) ANIMAL FOOD AND METHOD FOR PRODUCING SAME

(71) Applicant: AINSWORTH PET NUTRITION, Meadville, PA (US)

(72) Inventors: Thomas N. Asquith, Cincinnati, OH (US); Ruben Santana, Cranberry Township, PA (US); Shiva Garimella, Meadville, PA (US); Jeffrey S. Lang, Meadville, PA (US)

(73) Assignee: AINSWORTH PET NUTRITION, Meadville, PA (US)

(21) Appl. No.: 13/841,614

(22) Filed: Mar. 15, 2013

(51) Int. Cl. A23K 1/14; A23K 1/00

(52) U.S. Cl. CPC A23K 1/14; A23K 1/003
USPC 426/550; 426/549

(57) ABSTRACT

An animal food has a soft, chewy texture and a low water activity, includes starches such as wheat flour, wheat gluten, glycerin, soy flour, and high fructose corn syrup; a source of protein such as wheat gluten; polyols such as propylene glycol; distilled mono-glycerides; and a source of fat such as animal-based and vegetable-based fats, and preferably has a springiness, resilience, and hardness within a desired range. The animal food is preferably extruded.

### BACKGROUND

U.S. Patent Application Publication No. 2006/0134183 to Huetter et al. discloses a pet food comprising wheat flour and wheat gluten; high fructose corn syrup; glycerin and glyceryl monostearate; beet pulp; sodium tripolyphosphate; poultry fat; sulfur; minors; and water quantum satis. The water activity of the pet food is at least about 0.5, such as about 0.6. The pet food is designed to have tough texture for a long lasting chew.

U.S. Patent Application Publication No. 2009/0304897 to Tedrnan et al. discloses a peel-apart edible pet treat having a plurality of longitudinally oriented individual strands. The peel-apart edible pet treat can comprise glycerin in an amount of 0 to 10% and propylene glycol in an amount of 0 to 10%, but distilled mono-glycerides are not addressed.

U.S. Pat. No. 4,190,679 to Coffee et al, discloses a textured pet food with a fibrous internal structure. The textured pet food is said to constitute soft, moist, resilient, meat-like chunks of relative palatability. The texture pet food has a polyhydric alcohol content of from 2% to 15%, preferably from 5% to 9%.

U.S. Pat. No. 6,841,178 to Cupp et al. discloses a dental care pet food with a composition that can include a carbohydrate source of wheat and soy flour in the amount of 20% to 65% by weight. The dental care pet food contains about 2% to about 15% by weight of insoluble fiber and about 0.5% to about 15% by weight of humectant.

### SUMMARY

Embodiments of the animal food described herein preferably have a soft, springy texture and a relatively low water activity. Embodiments of the animal food described herein preferably comprise at least one source of starch, at least one source of protein, at least one source of fat, and at least one polyol. Embodiments of the animal food described herein can be intermixed with other food products such as dried feed products. Embodiments of methods for making animal food involve extrusion controlled to achieve desired properties.

### BRIEF DESCRIPTION OF THE DRAWINGS

FIG. 1 is a sample Texture Profile Analysis chart describing the measurements of springiness, resilience, and hardness.

FIGS. 2A and 2B are images of the internal structure of embodiments of the animal food described herein.

### DETAILED DESCRIPTION OF EMBODIMENTS

### Texture

Sensory properties of a food product can be objectively evaluated using a well-established technique referred to as Texture Profile Analysis. Texture Profile Analysis is primarily concerned with measuring mechanical properties of the food product. A set of Texture Profile Analysis parameters has been developed to define these mechanical properties in terms of the related sensory properties.

For example, suitable parameters for measuring the softness and chewiness of an animal food include springiness, resilience, and hardness. Values for textural parameters such as springiness, resilience, and hardness can be calculated from the results of a Texture Profile Analysis test. The values for springiness, resilience, and hardness discussed herein are calculated using data derived from a two-cycle Texture Profile Analysis test. See Food Texture & Viscosity: Concept and Measurement (Second Edition) by Malcolm Bourne, which is wholly incorporated herein by reference. The two-cycle test involves immobilizing a food-product sample having an average height of less than one inch, an average width of less than two inches, and an average length of three inches. The immobilized food-product sample then undergoes two compression cycles performed using a one-inch cylindrical probe fitted to a TAXT2i machine. The probe is calibrated for force and distance using standard calibration protocol.

Each compression cycle in the two-cycle test includes (1) a compression (i.e., a downward stroke of the probe applying force to the food-product sample), and (2) a withdrawal of the compression (i.e., an upward stroke of the probe releasing the force from the food-product sample). There is a wait period between the compression cycles.

The compressions in the two-cycle test are conducted for a range of strains from 50 to 100% compression, and preferably at 75% compression (relative to the sample height) at a crosshead speed of 5.0 mm/min. The withdrawal of the compression is at the same crosshead speed. The response of the food-product sample is recorded in the form of force, deformation, and time. A force-by-time curve plot derived from the test data is used to calculate values for the specific parameters.

Springiness is a measure of the ability of a product physically to spring back after being deformed during a first compression, the spring-back being measured at the down stroke of a second compression. Springiness values described herein represent the ratio of (a) the height of the food at the initiation of the down stroke of the second compression to (b) the height of the original sample. See FIG. 1.

Fresh embodiments can have different textural properties than aged embodiments. Fresh embodiments are embodiments stored with hard, dry pieces for less than thirty days. Aged embodiments are embodiments stored with hard, dry pieces for at least thirty days. The typical ratio of embodiments of the animal food to the hard, dry pieces is from 5:95 to 50:50. The hard, dry pieces could include any form, shape, or size of dry pet food or kibble, Fresh embodiments of the animal food preferably have a springiness of from 0.6 to 1.0, such as from 0.85 to 1.0, or from 0.9 to 1.0. Aged embodiments of the animal food preferably have a springiness of from 0.5 to 0.95, such as from 0.6 to 0.9, or from 0.65 to 0.85.

Resilience is a measure of how aggressively a product will attempt to regain its original position. Resilience is measured after withdrawal of a first compression, before the wait period begins. Resilience values described herein represent the ratio of (a) the work returned by the sample as compressive strain is removed to (b) the work required for compression. According to FIG. 1, resilience can be defined as Area 2/Area 1.

Fresh embodiments of the animal food preferably have a resilience of from 0.1 to 0.6, such as from 0.15 to 0.5, or from 0.2 to 0.4. Aged embodiments of the animal food preferably have a resilience of from 0.1 to 0.4, such as from 0.15 to 0.35, or from 0.2 to 0.3.

Hardness is a measure of the maximum force necessary to cause a given deformation. Hardness values described herein represent the peak of the first compression cycle, measured in grams. See FIG. 1.

Fresh embodiments of the animal food preferably have a hardness of from 50 to 100 grams, such as from 75 to 125 grams, or from 90 to 110 grams. Aged embodiments of the animal food preferably have a hardness of from 50 to 300 grams, such as from 90 to 250 grams, or from 100 to 200 grams.

### Composition

Embodiments of the animal food described herein preferably comprise at least one source of starch, at least one source of protein, at least one source of fat, and at least one polyol. Unless otherwise stated, the content of a component of the animal food is measured in percent by weight of the animal food.

Suitable sources of starch include flours from grains, tubers, and legumes as well as finely ground grains, tubers and legumes. Finely ground grain generally contains germ and bran, whereas flour does not contain at least germ. Suitable grains, tubers, and legumes include wheat, soy, tapioca, potato (such as sweet potato), pea, and rice.

The animal food preferably comprises at least one of the following sources of starch (individually or in combination): wheat flour in an amount of from 20% to 65%, such as from 25% to 60%, or from 35% to 50%; and soy flour in an amount of from 5% to 25%, such as from 7% to 23%, or from 10% to 16%. Embodiments of the animal food contain starch in an amount of from 10% to 70%, such as from 15% to 65%, or from 15% to 60%.

The flour in embodiments of the animal food preferably has a mean particle distribution of from about 30 μm to about 150 such as from 50 μm to about 1.30 μm, or from about 70 μm to about 110 μm.

The source of starch can be raw or pre-gelatinized. Further the starch can be modified. Modifications may include physical and/or chemical changes.

The above-mentioned flours, such as, for example, wheat flour and soy flour, can also serve as sources of fiber. The fiber content of the animal food is preferably from 0.5% to 1%, such as from about 0.6% to 0.9%, or from 0.7% to 0.8%.

The animal food preferably does not contain one or more of the following: oats, flaxseed, and psyllium.

Suitable sources of protein include meat, poultry, fish, eggs, grains, cereals, and legumes. Meat is the clean flesh derived from slaughtered mammals, and includes fresh meat, dried meat, and meat meals. Poultry is the clean flesh (with or without skin and/or bone) derived from parts or the whole carcasses of poultry (or a combination thereof), and includes fresh poultry, dried poultry, and poultry meals. Fish includes fresh fish, dried fish, and fish meals. Eggs include fresh egg, dried egg, egg yolk, and egg albumin. Suitable grain and cereals include rye, millet, corn, rice, wheat, bulgar, sorghum, amaranth, quinoa, and oats. For example, wheat gluten can be used as a source of protein. Suitable legumes include soybeans, lentils, kidney beans, white beans, mung beans, chickpeas, cowpeas, lima beans, green peas, pigeon peas, lupines, and wing beans. In some embodiments, the animal food may comprise one or more of the following: meat meals, poultry meals, bone meal, and collagen-based animal by-products.

Embodiments of the animal food contain a source of protein present in an amount of from 1% to 25%, such as from 2% to 20%, or from 10% to 20%.

Suitable sources of fat include oil or fat product of animal origin obtained by extracting oil or fat from animals that are processed for ingestion. Suitable animal-based fats include bovine, porcine, fish, and poultry fats. Poultry fat can be the only source of fat in the animal food.

Suitable sources of fat also include any oil product of vegetable origin obtained by extracting oil or fat from seeds or fruits that is processed for ingestion. Suitable vegetable-based fats include corn oil, soy oil, sunflower oil, canola oil, flax oil, and medium chain triglycerides. In some embodiments, the animal food does not comprise vegetable-based fats.

Embodiments of the animal food comprise fat in an amount of from 2% to 10%, such as from 2.5% to 8%, or from 3% to 7%.

Suitable polyols include glycerin, propylene glycol, sorbitol, erythritol, maltitol, mannitol, xylitol, sugar syrups, and molasses. Suitable sugar syrups include high fructose corn syrups, rice syrups, and barley syrups. Suitable molasses include corn molasses and sorghum molasses. Other syrups and molasses, sorbitol, erythritol, maltitol, mannitol, and xylitol can be used as replacements for glycerin and/or propylene glycol.

Embodiments of the animal food preferably comprise at least one of the following polyols (individually or in any combination): glycerin in the amount of from 5% to 35%, such as from 10% to 30%, or from 15% to 25%; high fructose corn syrup in the amount of 5% to 25%, such as from 8% to 22%, or from 10% to 20%; or propylene glycol in an amount of from 1% to 15%, such as from 3% to 12%.

In addition to the above polyols, embodiments of the animal food comprise distilled mono-glycerides in an amount of from 0.1% to 1%, such as from 0.2% to 0.9%, or from 0.3% to 0.7%. Embodiments that do not comprise distilled mono-glycerides can stale more quickly than embodiments that comprise distilled mono-glycerides. On the other hand, embodiments comprising distilled mono-glycerides remain springy and resilient.

The content of all polyols in the animal food is preferably from 15% to 45%, such as from 20% to 40%, or from 25% to 35%.

Embodiments of the animal food comprise sulfur. The content of sulfur in the animal food is preferably from 0% to less than 0.1%, such as from 0.01% to 0.09%, or from 0.02% to 0.08%.

Embodiments of the animal food comprise one or more additives. Suitable additives include minerals, colorants (including natural colorants), preservatives, probiotics, pre-biotics, enzymes (such as for dental care), palatants, and sprayed dried proteins. Suitable palatants include poultry flavoring, poultry digests, liver digests, eggs, egg yolk, and egg albumin. In some embodiments, the animal food does not comprise any meat flavorings other than poultry flavorings. Suitable sprayed dried protein additives include pea proteins and alfalfa extract.

The animal food may, but preferably does not, comprise aromatic agents, sugars, or sweetening agents.

The content of all minerals, colorants, and preservatives in the animal food is preferably from 1% to 5%, such as from 2% to 4%, or about 3%.

Embodiments of the animal food preferably comprise, in combination: wheat flour in an amount of from 40% to 45%; glycerin in an amount of from 15% to 25%; soy flour in an amount of from 10% to 16%; high fructose corn syrup in an amount of from 8% to 16%; propylene glycol in an amount of from 4% to 8%; wheat gluten in an amount of from 2% to 10%; poultry fat in an amount of from 3% to 7%; distilled mono-glycerides in an amount of from 0.2% to 0.7%; sulfur in an amount of less than 0.1%; and minerals, colorants, and preservatives together in an amount of about 3%.

The density of the animal food is preferably from 300 to 500 kg/m³, such as from 325 to 475 kg/m³, or from 350 to 450 kg/m³. A preferred density for pliability and toughness is about 400 kg/m³.

The internal structure of the animal food preferably is a foam-like structure having an expanded, e.g. radially expanded, continuous matrix, and cross-cut examination reveals homogeneous and well-distributed cavities or voids, as shown in FIGS. 2A and 2B. The structure of the animal food preferably is not a bundle of conjoined strands. The animal food preferably does not have layers.

Embodiments of the animal food can comprise water. Each component of the animal food preferably has a moisture content of from 5% to 25%, such as from 10% to 20%, or from 12% to 18%. The moisture content of the animal food as a whole is preferably from 5% to 25%, such as from 10% to 20%, or about 15%.

Embodiments of the animal food comprise the ingredients listed in Table 1 below.

TABLE 1

| Ingredient | Percent by weight |
|---|---|
| Wheat Flour | 35 to 50 |
| Glycerin | 15 to 25 |
| Soy Flour | 8 to 16 |
| High Fructose Corn Syrup | 8 to 16 |
| Propylene Glycol | 4 to 8 |
| Wheat Gluten | 2 to 10 |
| Poultry Fat | 2 to 8 |
| Distilled Mono-glycerides | 0.2 to 0.7 |
| Sulfur | <0.1 |
| Minerals, colors & preservatives | 3 |

Embodiments of the animal food preferably comprise the ingredients listed in Table 2 below.

TABLE 2

| Ingredient | Percent by weight |
|---|---|
| Wheat flour | 35 to 45 |
| Glycerin | 15 to 25 |
| Soy Flour | 8 to 15 |
| High fructose corn syrup | 8 to 15 |
| Propylene Glycol | 4 to 8 |
| Wheat Gluten | 1 to 5 |
| Poultry Fat | 4 to 8 |
| Distilled mono-glycerides | 0.2 to 0.6 |
| Sulfur | 0.01 to 0.05 |
| Minerals, colorants & vitamins | 1 to 4 |
| Process Water | 1 to 3 |

Embodiments of the animal food can be made into different shapes, such as circle shapes, heart shapes, crescent shapes, square shapes, etc.

Circle-shaped embodiments of the animal food can have: a diameter of from about 8 mm to about 14 mm, such as from 9 mm to 13 mm, or from 10 mm to 12.5 mm; and a width of from about 6 mm to about 12 mm, such as from 7 mm to 11 mm, or from 7.6 mm to 10.5 mm.

Heart-shaped embodiments of the animal food can have: a maximum height of from about 10 mm to about 15 mm, such as from 11 mm to 14 mm, or from 12.7 mm to 13.95 mm; a height, measured from the bottom tip of the heart shape to the indentation between the two lobes of the heart, of from about 8 mm to about 14 min, or from 9 mm to 13 mm, such as from 10 mm to 12.5 mm; and a width of from about 4 mm to about 9 mm, such as from 5 mm to 8 mm, or from 5.5 mm to 7.5 mm.

Crescent-shaped embodiments of the animal food can have: a maximum length of from about 15 mm to about 22 mm, such as from 16 mm to 21 mm, or from 17 mm to 20 mm; a width at the midpoint between apices of the crescent shape of from about 4 mm to about 11 mm, such as from 5 mm to 10 mm, or from 6 mm to 9 mm; and a width of from about 4 mm to about 10 mm, such as from 5 mm to 9 mm, or from 5.7 mm to 8.8 mm.

Square-shaped embodiments of the animal food can have: a length (of the sides of the square shape) of from about 10 mm to about 15 mm, such as from 11 mm to 14 mm, or from 12 mm to 13.1 mm; and a width of from about 9 mm to about 15 mm, such as from 10 mm to 14 mm, or from 10.9 mm to 13.3 mm.

Embodiments of the animal food can be intermixed with other food products. Suitable other food products include full feeding diets (extruded or baked) or treats (extruded, baked or molded). In embodiments, the proportion of the animal food intermixed with suitable full feeding diets is from 1% to 99%, such as from 20% to 80%, or from 35% to 65%, in embodiments, the proportion of the animal food intermixed with treats is from 1% to 99%, such as from 25% to 75%, or about 50%.

The composition of suitable treats is determined by desired aesthetics, desired palatability, cost, and manufacturing. The composition of suitable full feeding products is also determined by desired aesthetics, desired palatability, cost, and manufacturing as well as providing, for example, essential nutrients.

### Water Activity

Water activity (a_{w}) should not be confused with moisture content. Moisture content is the combination of free and bound moisture in the product. The relationship between moisture content and water activity depends on the particular composition. For example, silicone dioxide could absorb water up to 50% moisture content and maintain a very low water activity, while crystalline sucrose only has to absorb a small amount of water before reaching a water activity of 0.8.

Water activity refers to the amount of water in a composition that is not bound to other molecules, and therefore is available, for example, to support the growth of biological organisms such as bacteria, yeasts, molds and the like. The water activity of a product can have a direct impact on characteristics such as shelf life, product texture, moisture migration, caking, and clumping, to name a few.

The water activity of a particular composition can be expressed as a ratio of the water vapor pressure of the composition to the water vapor pressure of pure water under the same conditions, as expressed by the following formula:

a_{w}=p/pₒ
where
a_{w} is water activity
p is water vapor pressure of composition
pₒ is water vapor of water vapor pressure of pure water.

Water activity is measured by a scale that extends from 0 (over-dried silica) to 1 (pure water).

The following table (Table 3) illustrates the water activity level for growth of common spoilage microorganisms (adapted from Beuchat, L. R. 1983. Influence of water activity on growth, metabolic activities, and survival of yeasts and molds. J Food Prot 46:135-141, 150):

TABLE 3
Water Activity Level for Growth of Common Spoilage Microorganisms

| Water | |
|---|---|
| Activity | |
| (a_{W}) | Microorganisms generally inhibited by water activity at this level |
| 0.95 | Pseudomonas, Proteus, Shigella, Klebsiella, Bacillus, |
| | Clostridium perfringens, some yeasts, Escherichia coli |
| 0.91 | Salmonella, Vibrio parahaemolyticus, C. botulinum, Serratia, |
| | Lactobacillus, Pediococcus, some molds, Rhodotorula, Pichia, |
| | Bacillus cereus |
| 0.87 | Many yeasts (Candida, Torulopsis, Hansenula), Micrococcus |
| 0.77 | Aspergillus niger; Aspergillus ochraceous |
| 0.75 | Most halophilic bacteria, mycotoxigenic aspergilla, Aspergillus |
| | candidus, Aspergillus restrictus |
| 0.7 | Eurotium amstelodami |
| 0.65 | Xorophilic molds (Aspergillus chevalieri, A. Candidus, |
| | Wallemia sebi), Saccharomyces bisporus |
| 0.60 | Osmophilic yeasts (Saccharomyces rouxii), few molds |
| | (Aspergillus echinulatus, Monascus bisporus) |

Although temperature, acidity level (pH) and other factors can influence whether and how quickly bacteria and other microorganisms will grow in a product, water activity is still one of the most important factors in controlling spoilage to address safety concerns and lead to increased shelf life of pet foods and treats.

In addition, while controlling water activity, proper texture, structure, and density should be achieved.

Hard pet food typically falls in the range of 0.4 to 0.45 a_{w}. At this low level of available water, microbial stability is usually not an issue.

Pliable animal food typically falls in an intermediate range of 0.6 to 0.8 a_{w}. As a result, additional processing steps such as pasteurization, pH control, or the addition of preservatives may be required for production of pliable animal food. Each of these steps comes with potential adverse consequences such as added time and increased costs and burden, and adverse effects on temperature-sensitive ingredients and organoleptic properties.

Embodiments of the animal food described herein preferably have a water activity of from 0.50 to 0.75, such as from 0.55 to 0.70, or from 0.55 to 0.65.

### Methods

Animal food described herein can be produced by any method. Preferred methods produce animal food having low water activity and a soft, springy texture. The methods for making the animal food preferably do not use a retort. The methods for making the animal food preferably do not include infusion.

Embodiments of methods for producing the animal food preferably include extrusion processes. In general, in an extrusion processes, raw materials are first ground to a desired particle size, usually the consistency of flour, to make a preliminary mixture. The preliminary mixture is then passed through an extruder. The extruder generally comprises a stationary barrel, at least one rotating screw tightly fitting within the stationary barrel, and a die at the end of the barrel. The rotating screw forces the mixture through the die and the extruded mixture is collected.

In embodiments of extrusion processes, the preliminary mixture is heated in the extruder to a temperature of about 80° C. or greater, such as from greater than 83° C. to about 105° C., or from about 85° C. to about 100° C., or from about 90° C. to about 95° C. Overexpansion can occur when the preliminary mixture is heated to a temperature greater than 210° C. In embodiments, the mixture is not exposed to a convection heat source.

Processing times are unique to the type of extruder, configuration of the extruder, and the desired final appearance of the product.

An extruded mixture can puff or expand as it is extruded. Generally, puffing or expanding after extrusion is a result of a pressure drop or a rapid heat transfer. Embodiments of method preferably comprise a pressure drop after extrusion that results in puffing or expanding. The extent to which the extruded mixture expands can be referred to as the expansion ratio. The expansion ratio is a ratio of the dimension of the animal food to the dimension of the die opening. The expansion ratio of embodiments herein can be from about 1.5 to about 20, such as from about 3 to about 15, or from about 5 to about 10. After reaching the desired expansion, the expanded mixture can be cooled. The internal structure of the animal food can be a result of the expansion ratio.

Embodiments of the animal food are especially suitable for pets, i.e., an animal that is tamed or domesticated and kept as a companion, such as dogs and cats. The animal food can be useful for other animals including, but not limited to, domesticated animals, farm animals, wild animals, exotic pets and humans.

### EXAMPLES

Examples are set forth and are illustrative of different pet food compositions and conditions that can be utilized in practicing the disclosure. All proportions are by weight unless otherwise indicated. It will be apparent, however, that the disclosure can be practiced with many food compositions.

Examples 1-8 are embodiments of the animal food including the ingredients listed in Tables 4-11, respectively. The samples are extruded with an EXTRU-TECH 525. The temperature of the pre-conditioner is about 90° C.

TABLE 4
Example 1

| Ingredient | Percent by weight |
|---|---|
| Wheat flour | 64.59 |
| Glycerin | 13 |
| Soy Flour | 5 |
| High fructose corn syrup | 8 |
| Propylene Glycol | 4 |
| Wheat Gluten | 2 |
| Poultry Fat | 3 |
| Distilled mono-glycerides | 0.4 |
| Sulfur | 0.01 |

TABLE 5
Example 2

| Ingredient | Percent by weight |
|---|---|
| Wheat flour | 20 |
| Glycerin | 20 |
| Soy Flour | 18.76 |
| High fructose corn syrup | 15 |
| Propylene Glycol | 6 |
| Wheat Gluten | 5 |
| Poultry Fat | 8 |
| Distilled mono-glycerides | 0.2 |
| Sulfur | 0.04 |
| Minerals, colorants & vitamins | 4 |
| Process Water | 3 |

TABLE 6
Example 3

| Ingredient | Percent by weight |
|---|---|
| Wheat flour | 31.68 |
| Glycerin | 16 |
| Soy Flour | 25 |
| High fructose corn syrup | 10 |
| Propylene Glycol | 6 |
| Wheat Gluten | 2 |
| Poultry Fat | 5 |
| Distilled mono-glycerides | 0.3 |
| Sulfur | 0.02 |
| Minerals, colorants & vitamins | 1 |
| Process Water | 3 |

TABLE 7
Example 4

| Ingredient | Percent by weight |
|---|---|
| Wheat flour | 42 |
| Glycerin | 18 |
| Soy Flour | 10.5 |
| High fructose corn syrup | 11.5 |
| Propylene Glycol | 6 |
| Wheat Gluten | 2.2 |
| Poultry Fat | 6 |
| Distilled mono-glycerides | 0.4 |
| Sulfur | 0.02 |
| Minerals, colorants & vitamins | 2.4 |
| Process Water | 1 |

TABLE 8
Example 5

| Ingredient | Percent by weight |
|---|---|
| Wheat flour | 47.38 |
| Glycerin | 18 |
| Soy Flour | 10.5 |
| High fructose corn syrup | 11.5 |
| Propylene Glycol | 6 |
| Wheat Gluten | 2.2 |
| Poultry Fat | 2 |
| Distilled mono-glycerides | 0.4 |
| Sulfur | 0.02 |
| Minerals, colorants & vitamins | 2 |

TABLE 9
Example 6

| Ingredient | Percent by weight |
|---|---|
| Wheat flour | 40.58 |
| Glycerin | 12 |
| Soy Flour | 10.5 |
| High fructose corn syrup | 20 |
| Propylene Glycol | 5 |
| Wheat Gluten | 2 |
| Poultry Fat | 6 |
| Distilled mono-glycerides | 0.4 |
| Sulfur | 0.02 |
| Minerals, colorants & vitamins | 1.5 |
| Process Water | 2 |

TABLE 10
Example 7

| Ingredient | Percent by weight |
|---|---|
| Wheat flour | 39.58 |
| Glycerin | 25 |
| Soy Flour | 10 |
| High fructose corn syrup | 10 |
| Propylene Glycol | 6 |
| Wheat Gluten | 2 |
| Poultry Fat | 5 |
| Distilled mono-glycerides | 0.4 |
| Sulfur | 0.02 |
| Minerals, colorants & vitamins | 1 |
| Process Water | 1 |

TABLE 11
Example 8

| Ingredient | Percent by weight |
|---|---|
| Wheat flour | 41.86 |
| Glycerin | 18 |
| Soy Flour | 10.5 |
| High fructose corn syrup | 11.5 |
| Propylene Glycol | 6 |
| Wheat Gluten | 2.2 |
| Poultry Fat | 6 |
| Distilled mono-glycerides | 0.9 |
| Sulfur | 0.04 |
| Minerals, colorants & vitamins | 2 |
| Process Water | 1 |

It will be appreciated that variations of the above-disclosed and other features and functions, or alternatives thereof, can be desirably combined into many different applications. Also, variously presently unforeseen or unanticipated alternatives, modifications, variations, or improvements therein can be subsequently made by those skilled in the art, and are also intended to be encompassed by the following claims.

What is claimed is:

1. An animal food comprising:
a source of starch;
a source of protein;
a source of fat;
distilled mono-glycerides; and
a polyol other than distilled mono-glycerides,
wherein the animal food has a springiness of from 0.6 to 1.0, a resilience of from 0.1 to 0.6, and a hardness of from 50 to 100 grams.

2. The animal food according to claim 1, wherein the water activity of the food is from 0.5 to 0.7.

3. The animal food according to claim 1, wherein the source of starch comprises wheat flour in an amount of from 20% to 65% and soy flour in an amount of from 5% to 25%.

4. The animal food according to claim 1, wherein the source of fat is present in the animal food in an amount of 1% to 15%.

5. The animal food according to claim 1, wherein the polyol comprises glycerin in an amount of from 5% to 35%; high fructose corn syrup in an amount from 3% to 25%; and propylene glycol in an amount of from 1% to 15%.

6. The animal food according to claim 1, wherein the animal food comprises sulfur in an amount less than 1%.

7. The animal food according to claim 1, wherein the animal food comprises:
20% to 65% wheat flour;
5% to 25% soy flour;
3% to 25% high fructose corn syrup;
1% to 15% wheat gluten;
1% to 15% fat;
5% to 35% glycerin;
1% to 15% propylene glycol;
0.2% to 0.7% distilled mono-glycerides; and
sulfur in an amount less than 0.1%.

8. The animal food according to claim 1, wherein the density of the animal food is from 300 to 500 kg/m³.

9. The animal food according to claim 1, wherein the fiber content of the animal food is from 0.5% to 1%.

10. The animal food according to claim 1, wherein an internal structure of the animal food is a foam-like structure comprising a radially expanded, continuous matrix of voids.

11. The animal food according to claim 1, wherein the animal food is fresh animal food.

12. The animal food according to claim 11, wherein, when the animal food is aged, the animal food has a springiness of from 0.5 to 0.95, a resilience of from 0.1 to 0.4, and a hardness of from 50 to 300 grams.

13. An animal food comprising:
wheat flour;
soy flour;
high fructose corn syrup;
wheat gluten;
fat;
glycerin;
propylene glycol; and
distilled mono-glycerides.

14. The animal food according to claim 13, wherein the animal food comprises:
20% to 65% wheat flour;
5% to 25% soy flour;
3% to 25% high fructose corn syrup;
1% to 15% wheat gluten;
1% to 15% fat;
5% to 35% glycerin;
1% to 15% propylene glycol;
0.2% to 0.7% distilled mono-glycerides; and
sulfur in an amount less than 0.1%.

15. The animal food according to claim 13, wherein
the animal food has a springiness of from 0.6 to 1.0, a resilience of from 0.1 to 0.6, and a hardness of from 50 to 100 grams, and
a water activity of the animal food is from 0.5 to 0.7.

16. The animal food according to claim 13, wherein the density of the animal food is from 300 to 500 kg/m³.

17. The animal food according to claim 13, wherein the fiber content of the animal food is from 0.5% to 1%.

18. The animal food according to claim 13, wherein an internal structure of the animal food is a foam-like structure comprising a radially expanded, continuous matrix of voids.

19. The animal food according to claim 13, wherein the animal food is fresh animal food.

20. The animal food according to claim 13, wherein, when the animal food is aged, the animal food has a springiness of from 0.5 to 0.95, a resilience of from 0.1 to 0.4, and a hardness of from 50 to 300 grams.

21. The animal food according to claim 13, wherein the animal food comprises:
35% to 45% wheat flour;
15% to 25% glycerin;
8% to 15% soy flour;
8% to 15% high fructose corn syrup;
4% to 8% propylene glycol;
1% to 5% wheat gluten;
4% to 8% poultry fat;
0.2% to 0.6 distilled mono-glycerides;
0.01% to 0.05% sulfur;
1% to 4% minerals, colorants, and vitamins; and
1% to 3% process water.

22. A method for producing an animal food comprising:
feeding a primary mixture into an extruder, the primary mixture comprising a source of starch, a source of protein, a source of fat, distilled mono-glycerides, and a polyol other than distilled mono-glycerides;
heating the primary mixture in the extruder;
extruding the heated mixture from the extruder to form an extruded product; and
collecting the extruded product after it exits the extruder;
wherein the extruded product has a springiness of from 0.6 to 1.0, a resilience of from 0.1 to 0.6, and a hardness of from 50 to 100 grams.

23. The method according to claim 22, wherein, in the extruder, the primary mixture is heated to a temperature of 80° C. or greater.

24. The method according to claim 22, wherein the extruded product expands as it exits the extruder as a result of a pressure drop.

25. The method according to claim 22, wherein the primary mixture comprises wheat flour, glycerin, soy flour, high fructose corn syrup, propylene glycol, wheat gluten, fat, and distilled mono-glycerides.

26. The method according to claim 22, wherein the primary mixture comprises:
20% to 65% wheat flour;
5% to 25% soy flour;
3% to 25% high fructose corn syrup;
1% to 15% wheat gluten;
1% to 15% poultry fat;
5% to 35% glycerin;
1% to 15% propylene glycol;
0.2% to 0.7% distilled mono-glycerides; and
sulfur in an amount less than 0.1%.

27. The method according to claim 22, wherein the density of the animal food is from 300 to 500 kg/m³.

28. The method according to claim 22, wherein the fiber content of the animal food is from 0.5% to 1%.

29. The method according to claim 22, wherein an internal structure of the extruded product is a foam-like structure comprising a radially expanded, continuous matrix of voids.

30. The animal food according to claim 22, wherein, when the extruded product is aged, the extruded product has a springiness of from 0.5 to 0.95, a resilience of from 0.1 to 0.4, and a hardness of from 50 to 300 grams.
